(19) United States
(12) Patent Application Publication
(10) Pub. No.: US 2024/0250312 A1
(43) Pub. Date: Jul. 25, 2024

(54) Bipolar Storage Battery, Method For Manufacturing Bipolar Storage Battery, And Bipolar Lead-Acid Storage Battery

(71) Applicants: The Furukawa Battery Co., Ltd., Yokohama (JP); Furukawa Electric Co., Ltd., Tokyo (JP)

(72) Inventor: Ayano KOIDE, Iwaki (JP)

(21) Appl. No.: 18/482,514

(22) Filed: Oct. 6, 2023

Related U.S. Application Data
(63) Continuation of application No. PCT/JP2022/003587, filed on Jan. 31, 2022.

(30) Foreign Application Priority Data
Apr. 8, 2021 (JP) 2021-065939
May 14, 2021 (JP) 2021-082472

(51) Int. Cl. H01M 10/18; H01M 4/68; H01M 10/12; H01M 50/477; H01M 50/486

(52) U.S. Cl. CPC H01M 10/18; H01M 4/68; H01M 4/685; H01M 10/12; H01M 50/477; H01M 50/486

(57) ABSTRACT

In a bipolar storage battery where a positive electrode current collector plate and a negative electrode current collector plate are electrically connected in a through-hole of a substrate and a plurality of cell members are electrically connected in series, even when an electrolytic solution moves between the current collector plate and the substrate, the electrolytic solution is prevented from easily reaching the through-hole of the substrate, preventing a short circuit. At least one of a bottom surface of a recess that is a surface of a main substrate close to a positive electrode or a bottom surface of a recess that is a surface of the main substrate close to a negative electrode, the main substrate being a substrate arranged between cell members, has a ten-point average roughness (RzJIS) of between 30 μm and 104 μm, inclusive, and a maximum height roughness (Rz) of 123 μm or less.

### CROSS-REFERENCE TO RELATED APPLICATION(S)

This application is a continuation of PCT Application No. PCT/JP2022/003587, filed Jan. 31, 2022, the disclosure of which is incorporated herein in its entirety by reference.

### TECHNICAL FIELD

The present invention relates to a bipolar storage battery, a method for manufacturing the bipolar storage battery, and a bipolar lead-acid storage battery.

### BACKGROUND

In recent years, the number of power generation facilities using natural energy such as sunlight and wind power has increased. In such power generation facilities, because the power generation amount cannot be controlled, the power load is leveled by using a storage battery. That is, when the amount of power generation is larger than a consumption, a difference is charged into the storage battery, and when the amount of power generation is smaller than a consumption, a difference is discharged from the storage battery. As the storage battery described above, a lead-acid storage battery is frequently used from the viewpoint of economic efficiency, safety, and the like. As such a conventional lead-acid storage battery, for example, a bipolar lead-acid storage battery described in JP Patent Publication No. 6124894 B2 is known.

The bipolar lead-acid storage battery has a frame shape and has a resin substrate attached to the inside of a resin frame. Lead layers are arranged on both surfaces of the substrate. A positive active material layer is adjacent to the lead layer formed on one surface of the substrate, and a negative active material layer is adjacent to the lead layer formed on the other surface of the substrate. In addition, a resin spacer having a frame shape is provided, and a glass mat impregnated with an electrolytic solution is provided inside the spacer. A plurality of frames and spacers are alternately stacked, and the frames and the spacers are bonded to each other with an adhesive or the like. In addition, the lead layers formed on both surfaces of the substrate are connected via a through-hole provided in the substrate.

That is, the bipolar lead-acid storage battery described in JP Patent Publication No. 6124894 B2 includes a plurality of cell members each including a positive electrode including a positive electrode current collector plate and a positive active material layer, a negative electrode including a negative electrode current collector plate and a negative active material layer, and a separator (e.g., a glass mat) interposed between the positive electrode and the negative electrode. The plurality of cell members is arranged in a stack manner with intervals. The bipolar lead-acid storage battery also includes a plurality of space forming members each forming a plurality of spaces for individually housing the plurality of cell members, wherein both the positive electrode current collector plate and the negative electrode current collector plate are formed of a metal (e.g., lead).

In addition, the space forming member includes a substrate that covers at least one of a side of the positive electrode and a side of the negative electrode of the cell member, and a frame body (i.e., a frame portion and a spacer of a bipolar plate and an end plate) that surrounds a side surface of the cell member. Further, the cell member and the substrate of the space forming member are arranged to be alternately stacked. The substrate arranged between the cell members adjacent to each other has a through-hole extending in a direction intersecting with a plate surface. The positive electrode current collector plate and the negative electrode current collector plate of the cell members adjacent to each other are electrically connected to each other in the through-hole. The plurality of cell members are electrically connected in series. The frame bodies adjacent to each other are joined to each other.

However, in JP Patent Publication No. 6124894 B2, a lead foil that is a positive electrode current collector plate or a negative electrode current collector plate is simply stated that “the lead foil is arranged in a material receiving passage of the frame on both exposed surfaces of the substrate”. It is not described that the lead foil is fixed to the substrate with an adhesive, and there is no description suggesting the fixing.

### SUMMARY

As described above, in the case of the bipolar storage battery in which the positive electrode current collector plate and the negative electrode current collector plate are electrically connected to each other in the through-hole of the substrate and the plurality of cell members are electrically connected in series, when the current collector plate is corroded and the electrolytic solution present in the active material layer moves between the substrate and the current collector plate, the electrolytic solution reaches the opposite current collector plate via the through-hole, a liquid junction phenomenon may occur, and a short circuit may occur. In this liquid junction phenomenon, even in a case where the current collector plate is fixed to the substrate with an adhesive, when there is a portion where the adhesive layer does not exist, the electrolytic solution may move between the current collector plate and the substrate and reach the through-hole.

A first object of the present invention is to prevent an electrolytic solution from easily reaching a through-hole even in a case where the electrolytic solution moves between a current collector plate and a substrate in a bipolar storage battery in which a positive electrode current collector plate and a negative electrode current collector plate are electrically connected to each other in a through-hole of a substrate and a plurality of cell members are electrically connected in series, thereby preventing a short circuit.

On the other hand, one of the causes of deterioration of the lead-acid storage battery is corrosion of the positive electrode current collector plate. As the battery use period becomes longer, corrosion of the positive electrode current collector plate progresses. When the corrosion progresses, the positive active material cannot be held, and the performance as a battery is deteriorated. In addition, in a case where a positive electrode material (e.g., a positive electrode current collector plate or a positive active material) falling off due to corrosion comes into contact with the negative electrode, a short circuit may occur.

In particular, in a case of a bipolar lead-acid storage battery, because a current distribution is a reaction on the surface, there is no need to consider charge transfer resistance, and it is possible to thin the current collector plate. However, because a distance between the positive electrode and the negative electrode is short, there is a risk that a fatal defect occurs when the corrosion of the positive electrode current collector plate is large. Thus, it is required to suppress the corrosion of the positive electrode current collector plate. However, because a lead alloy having high corrosion resistance hardly reacts with an active material, a lead foil formed of a lead alloy having high corrosion resistance is poor in adhesion to an active material layer.

A second object of the present invention is to improve adhesion between a lead foil formed of a lead alloy having high corrosion resistance and an active material layer in a bipolar lead-acid storage battery including a lead foil formed of a lead alloy having high corrosion resistance as a current collector plate.

In order to achieve the first object described above, a first aspect of the present invention is a bipolar storage battery having the following configurations (1) to (4).

(1) A bipolar storage battery includes a plurality of cell members each including a positive electrode including a positive electrode current collector plate and a positive active material layer, a negative electrode including a negative electrode current collector plate and a negative active material layer, and a separator interposed between the positive electrode and the negative electrode. The plurality of cell members is arranged in a stack manner with intervals. The bipolar storage battery also includes a plurality of space forming members each forming a plurality of spaces for individually housing the plurality of cell members.

(2) Each space forming member includes a substrate formed of a synthetic resin that covers both a side of the positive electrode and a side of the negative electrode of the cell member, and a frame body that surrounds a side surface of the cell member. The plurality of cell members and the substrate of each space forming member are arranged to be alternately stacked. The frame bodies adjacent to each other are joined to each other.

(3) At least one of a surface of a main substrate close to the positive electrode and a surface of the main substrate close to the negative electrode, the main substrate being the substrate arranged between the cell members adjacent to each other, has a ten-point average roughness (RzJIS) of 30 μm or more and 104 μm or less when measured in accordance with a stipulation of “Annex JA of JIS B 0601:2013”, and a maximum height roughness (Rz) of 123 μm or less when measured in accordance with the stipulation.

(4) The positive electrode current collector plate formed of a metal is fixed to the surface of the main substrate close to the positive electrode with an adhesive, the main substrate being the substrate arranged between the cell members adjacent to each other. The negative electrode current collector plate formed of a metal is fixed to the surface of the main substrate close to the negative electrode with an adhesive. The main substrate has a through-hole extending in a direction intersecting with a plate surface, the positive electrode current collector plate and the negative electrode current collector plate of the cell members adjacent to each other are electrically connected to each other in the through-hole, and the plurality of cell members are electrically connected in series.

In order to achieve the first object described above, a second aspect of the present invention is a method for manufacturing a bipolar storage battery having the configurations (1), (2), and (4), and has the following configuration (5).

(5) As the main substrate, a main substrate, in which at least one of a surface of the main substrate close to the positive electrode and a surface of the main substrate close to the negative electrode has a ten-point average roughness (RzJIS) of 30 μm or more and 104 μm or less when measured in accordance with a stipulation of “Annex JA of JIS B 0601:2013”, and a maximum height roughness (Rz) of 123 μm or less when measured in accordance with the stipulation, is used.

In order to achieve the second object described above, a third aspect of the present invention is a bipolar lead-acid storage battery having the following configurations (11) to (14).

(11) A bipolar lead-acid storage battery includes a plurality of cell members each including a positive electrode in which a positive active material layer is arranged on one surface of a positive electrode lead foil formed of lead or a lead alloy, a negative electrode in which a negative active material layer is arranged on one surface of a negative electrode lead foil formed of lead or a lead alloy, and a separator interposed between the positive electrode and the negative electrode. The plurality of cell members is arranged in a stack manner with intervals. The bipolar lead-acid storage battery also includes a plurality of space forming members each forming a plurality of spaces for individually housing the plurality of cell members.

(12) Each space forming member includes a substrate formed of a synthetic resin that covers both a side of the positive electrode and a side of the negative electrode of the cell member, and a frame body that surrounds a side surface of the cell member. The plurality of cell members and the substrate of each space forming member are arranged to be alternately stacked. The frame bodies adjacent to each other are joined to each other.

(13) The positive electrode lead foil and the negative electrode lead foil each have a portion having a granular structure. At least one of an interface of the positive electrode lead foil with the positive active material layer and an interface of the negative electrode lead foil with the negative active material layer has a portion formed in the granular structure, and has a ten-point average roughness (RzJIS) of 50 μm or more when measured in accordance with a stipulation of “Annex JA of JIS B 0601:2013”, and a maximum height roughness (Rz) smaller than ½ of a mean particle size of particles constituting the granular structure when measured in accordance with the stipulation.

(14) The substrate arranged between the cell members adjacent to each other has a through-hole extending in a direction intersecting with a plate surface, the positive electrode lead foil and the negative electrode lead foil of the cell members adjacent to each other are electrically connected to each other in the through-hole, and the plurality of cell members are electrically connected in series.

In the bipolar storage battery of the present invention and the bipolar storage battery obtained by the method of the present invention, even in a case where the electrolytic solution moves between the current collector plate and the substrate, it is possible to prevent the electrolytic solution from easily reaching the through-hole, thereby obtaining a short circuit prevention effect.

The bipolar lead-acid storage battery of the present invention can be expected to have excellent adhesion between a lead foil (i.e., a current collector plate) formed of a lead alloy having high corrosion resistance and an active material layer.

### BRIEF DESCRIPTION OF THE DRAWINGS

FIG. 1 is a cross-sectional view illustrating a schematic configuration of a bipolar lead-acid storage battery according to an embodiment of the present invention.

FIG. 2 is a partially enlarged view of the bipolar lead-acid storage battery of FIG. 1.

FIG. 3 is a micrograph depicting a metallic structure of a cross section of the lead foil No. 2-1.

FIG. 4 is a micrograph depicting a metallic structure of a cross section of the lead foil No. 2-6.

### DETAILED DESCRIPTION

Hereinafter, embodiments of the present invention will be described, but the present invention is not limited to the following embodiments. In the embodiments described below, technically preferable limitations are made to implement the present invention, but no limitation is an essential requirement of the present invention. Hereinafter, explanation will be given using a bipolar lead-acid storage battery as an example of a bipolar storage battery.

### First Embodiment

### Overall Configuration

First, an overall configuration of a bipolar lead-acid storage battery of an embodiment will be described.

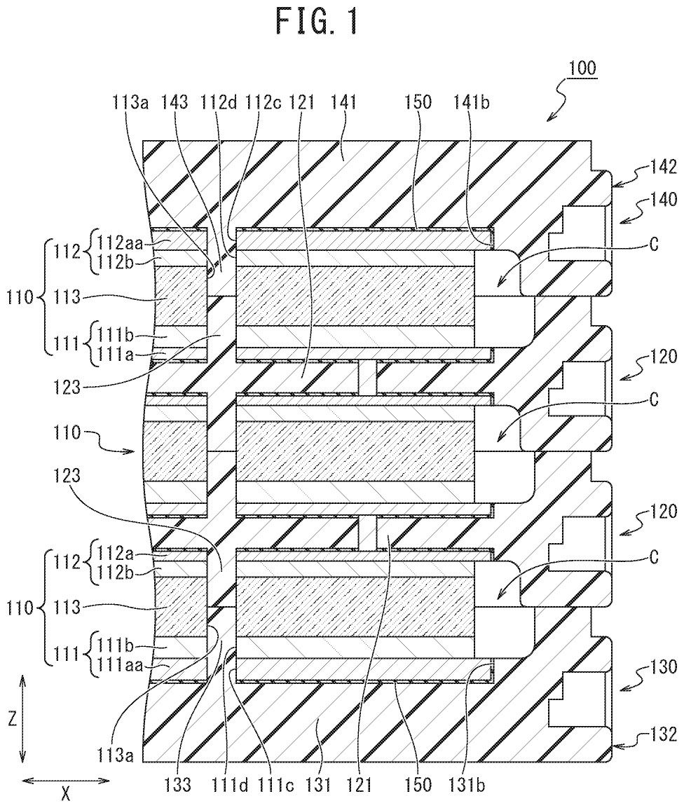

As illustrated in FIG. 1, a bipolar lead-acid storage battery 100 of the embodiment includes a plurality of cell members 110, a plurality of biplates 120 (as space forming members), a first end plate 130 (as a space forming member), and a second end plate 140 (as a space forming member). FIG. 1 illustrates the bipolar lead-acid storage battery 100 in which three cell members 110 are stacked, but the number of cell members 110 is determined by battery design. In addition, the number of the biplates 120 is determined according to the number of the cell members 110.

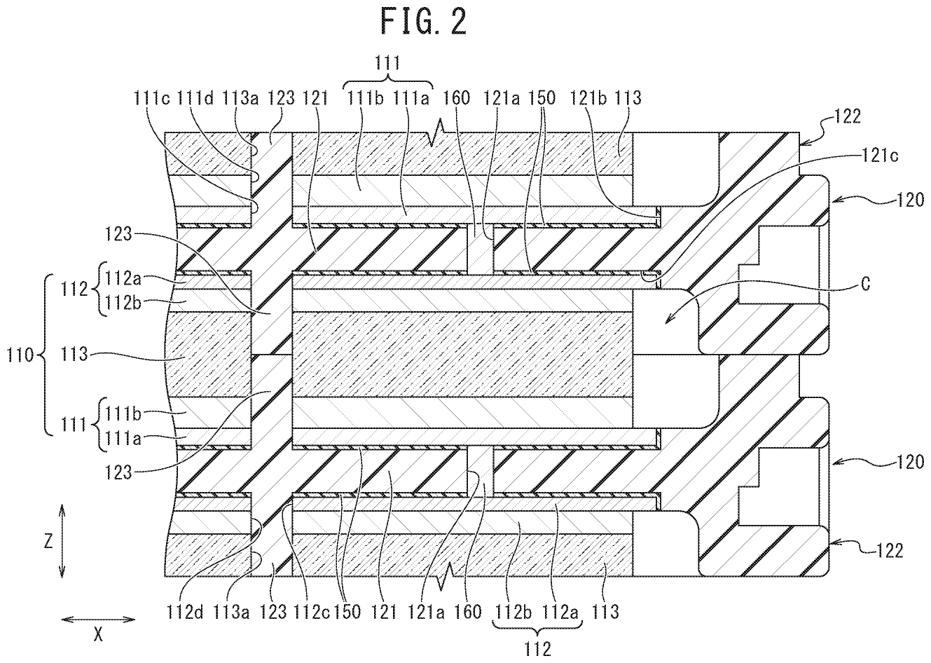

A stacking direction of the cell members 110 is defined as a Z direction (vertical direction in FIGS. 1 and 2), and a direction perpendicular to the Z direction is defined as an X direction.

The cell member 110 includes a positive electrode 111, a negative electrode 112, and a separator 113 (electrolyte layer). The separator 113 is impregnated with an electrolytic solution. The positive electrode 111 includes positive electrode lead foils 111a and 111aa (positive electrode current collector plates) and a positive active material layer 111b. The negative electrode 112 includes negative electrode lead foils 112a and 112aa (negative electrode current collector plates) and a negative active material layer 112b. The separator 113 is interposed between the positive electrode 111 and the negative electrode 112. In the cell member 110, the positive electrode lead foils 111a and 111aa, the positive active material layer 111b, the separator 113, the negative active material layer 112b, and the negative electrode lead foils 112a and 112aa are stacked in this order.

A dimension (e.g., a thickness) in the Z direction is larger (thicker) in the positive electrode lead foil 111a than in the negative electrode lead foil 112a and is larger (thicker) in the positive active material layer 111b than in the negative active material layer 112b.

The plurality of cell members 110 are arranged in a stack manner with intervals in the Z direction, and a substrate 121 of the biplate 120 is arranged at the interval. That is, the plurality of cell members 110 are stacked with the substrate 121 of the biplate 120 interposed therebetween.

The plurality of biplates 120, the first end plate 130, and the second end plate 140 are members for forming a plurality of spaces C (also called cells) for individually housing the plurality of cell members 110.

As illustrated in FIG. 2, the biplate 120 includes a substrate 121 having a rectangular planar shape, a frame body 122 covering four end surfaces of the substrate 121, and column portions 123 vertically protruding from both surfaces of the substrate 121. The substrate 121, the frame body 122, and the column portions 123 are integrally formed of a synthetic resin. Note that the number of column portions 123 protruding from each surface of the substrate 121 may be one or more.

In the Z direction, a dimension of the frame body 122 is larger than a dimension (e.g., a thickness) of the substrate 121, and a dimension between protruding end surfaces of the column portions 123 is the same as the dimension of the frame body 122. A space C is formed between the substrate 121 and the substrate 121 by stacking the plurality of biplates 120 in contact with the frame body 122 and the column portions 123. A dimension of the space C in the Z direction is maintained by the column portions 123 that are in contact with each other.

Through-holes 111c, 111d, 112c, 112d, and 113a penetrating the column portion 123 are formed in the positive electrode lead foils 111a and 111aa, the positive active material layer 111b, the negative electrode lead foils 112a and 112aa, the negative active material layer 112b, and the separator 113, respectively.

A substrate 121 (e.g., a main substrate) of the biplate 120 has a plurality of through-holes 121a penetrating the plate surface. A first recess 121b is formed on one surface of the substrate 121, and a second recess 121c is formed on the other surface of the substrate 121. A depth of the first recess 121b is deeper than that of the second recess 121c. Dimensions of the first recess 121b and the second recess 121c in the X direction and the Y direction correspond to the dimensions of the positive electrode lead foil 111a and the negative electrode lead foil 112a in the X direction and the Y direction.

In addition, each of a bottom surface of the first recess 121b (i.e., a surface of the substrate 121 close to the positive electrode 111) and a bottom surface of the second recess 121c (i.e., surface of the substrate 121 close to the negative electrode 112) has a ten-point average roughness (RzJIS) of 30 μm or more and 104 μm or less (i.e., between 30 μm and 104 μm, inclusive) when measured in accordance with a stipulation of “Annex JA of JIS B 0601:2013”, and a maximum height roughness (Rz) of 123 μm or less when measured in accordance with the stipulation.

The substrate 121 of the biplate 120 is arranged between the cell members 110 adjacent to each other in the Z direction. The substrate 121 of the biplate 120 is a substrate that covers both a side of the positive electrode 111 of the cell member 110 and a side of the negative electrode 112 of the cell member 110 adjacent thereto. The positive electrode lead foil 111a of the cell member 110 is arranged in the first recess 121b of the substrate 121 of the biplate 120 with an adhesive layer 150 interposed therebetween. That is, the positive electrode lead foil 111a is fixed to the surface of the substrate 121 close to the positive electrode 111 (e.g., the bottom surface of the first recess 121b) with an adhesive.

In addition, the negative electrode lead foil 112a of the cell member 110 is arranged in the second recess 121c of the substrate 121 of the biplate 120 with the adhesive layer 150 interposed therebetween. That is, the negative electrode lead foil 112a is fixed to the surface of the substrate 121 close to the negative electrode 112 (e.g., the bottom surface of the second recess 121c) with an adhesive.

An electrical conductor 160 is arranged in the through-hole 121a of the substrate 121 of the biplate 120, and both end surfaces of the electrical conductor 160 are in contact with and coupled to the positive electrode lead foil 111a and the negative electrode lead foil 112a. That is, the positive electrode lead foil 111a and the negative electrode lead foil 112a are electrically connected by the electrical conductor 160. As a result, all of the plurality of cell members 110 are electrically connected in series.

As illustrated in FIG. 1, the first end plate 130 includes a substrate 131 that covers a side of the positive electrode 111 of the cell member 110, a frame body 132 that surrounds the side surface of the cell member 110, and a column portion 133 that vertically protrudes from one surface of the substrate 131 (a surface of the biplate 120 arranged closest to the side of the positive electrode 111, the surface facing the substrate 121). A planar shape of the substrate 131 is rectangular, and four end surfaces of the substrate 131 are covered with the frame body 132. The substrate 131, the frame body 132, and the column portion 133 are integrally formed of a synthetic resin. Note that the number of column portions 133 protruding from one surface of the substrate 131 may be one or more but corresponds to the column portion 123 of the biplate 120 to be brought into contact with the column portion 133.

In the Z direction, a dimension of the frame body 132 is larger than a dimension (e.g., a thickness) of the substrate 131, and a dimension between protruding end surfaces of the column portion 133 is the same as the dimension of the frame body 132. A space C is formed between the substrate 121 of the biplate 120 and the substrate 131 of the first end plate 130 by stacking the frame body 132 and the column portion 133 in contact with the frame body 122 and the column portion 123 of the biplate 120 arranged on the outermost side (e.g., the positive electrode side). A dimension of the space C in the Z direction is maintained by the column portion 123 of the biplate 120 and the column portion 133 of the first end plate 130, which are in contact with each other.

Through-holes 111c, 111d, and 113a penetrating the column portion 133 are formed in the positive electrode lead foil 111aa, the positive active material layer 111b, and the separator 113 of the cell member 110 arranged on the outermost side (e.g., the positive electrode side), respectively.

A recess 131b is formed on one surface of the substrate 131 of the first end plate 130. A dimension of the recess 131b in the X direction corresponds to a dimension of the positive electrode lead foil 111aa in the X direction. The dimension of the positive electrode lead foil 111aa arranged on one surface of the substrate 131 of the first end plate 130 in the Z direction is larger than a dimension of the positive electrode lead foil 111a arranged on one surface of the substrate 121 of the biplate 120 in the Z direction.

The positive electrode lead foil 111aa of the cell member 110 is arranged in the recess 131b of the substrate 131 of the first end plate 130 with the adhesive layer 150 interposed therebetween. That is, the positive electrode lead foil 111aa is fixed to the surface of the substrate 131 close to the positive electrode 111 (e.g., the bottom surface of the recess 131b) with an adhesive.

In addition, the first end plate 130 includes a positive electrode terminal electrically connected to the positive electrode lead foil 111aa in the recess 131b.

The second end plate 140 includes a substrate 141 that covers the negative electrode 112 of the cell member 110, a frame body 142 that surrounds the side surface of the cell member 110, and a column portion 143 that vertically protrudes from one surface of the substrate 141 (a surface of the biplate 120 arranged closest to the negative electrode 112, the surface facing the substrate 121). A planar shape of the substrate 141 is rectangular, and four end surfaces of the substrate 141 are covered with the frame body 142. The substrate 141, the frame body 142, and the column portion 143 are integrally formed of a synthetic resin. Note that the number of column portions 143 protruding from one surface of the substrate 141 may be one or more but corresponds to the column portion 123 of the biplate 120 to be brought into contact with the column portion 143.

In the Z direction, a dimension of the frame body 142 is larger than a dimension (e.g., a thickness) of the substrate 131, and a dimension between two protruding end surfaces of the column portion 143 is the same as the dimension of the frame body 142. A space C is formed between the substrate 121 of the biplate 120 and the substrate 141 of the second end plate 140 by stacking the frame body 142 and the column portion 143 in contact with the frame body 122 and the column portion 123 of the biplate 120 arranged on the outermost side (e.g., the negative electrode side). A dimension of the space C in the Z direction is maintained by the column portion 123 of the biplate 120 and the column portion 143 of the second end plate 140, which are in contact with each other.

Through-holes 112c, 112d, and 113a penetrating the column portion 143 are formed in the negative electrode lead foil 112aa, the negative active material layer 112b, and the separator 113 of the cell member 110 arranged on the outermost side (e.g., the negative electrode side), respectively.

A recess 141b is formed on one surface of the substrate 141 of the second end plate 140. A dimension of the recess 141b in the X direction and the Y direction corresponds to a dimension of the negative electrode lead foil 112aa in the X direction and the Y direction. The dimension of the negative electrode lead foil 112aa arranged on one surface of the substrate 141 of the second end plate 140 in the Z direction is larger than a dimension of the negative electrode lead foil 112a arranged on the other surface of the substrate 121 of the biplate 120 in the Z direction.

The negative electrode lead foil 112aa of the cell member 110 is arranged in the recess 141b of the substrate 141 of the second end plate 140 with the adhesive layer 150 interposed therebetween. That is, the negative electrode lead foil 112aa is fixed to the surface of the substrate 141 close to the negative electrode 112 (e.g., the bottom surface of the recess 141b) with an adhesive.

In addition, the second end plate 140 includes a negative electrode terminal electrically connected to the negative electrode lead foil 112aa in the recess 141b.

Note that, as can be seen from the above description, the biplate 120 is a space forming member including the substrate 121 that covers both a side of the positive electrode 111 and a side of the negative electrode 112 of the cell member 110 and the frame body 122 that surrounds the side surface of the cell member 110. The first end plate 130 is a space forming member including the substrate 131 that covers only a side of the positive electrode 111 (i.e., one of a side of the positive electrode 111 or a side of the negative electrode 112) of the cell member 110 and the frame body 132 that surrounds the side surface of the cell member 110.

In addition, the second end plate 140 is a space forming member including the substrate 141 that covers only a side of the negative electrode 112 (i.e., one of a side of the positive electrode 111 or a side of the negative electrode 112) of the cell member 110 and the frame body 142 that surrounds the side surface of the cell member 110. That is, each of the substrates 121, 131, and 141 is a substrate that covers at least one of a side of the positive electrode 111 and a side of the negative electrode 112 of the cell member 110, and the substrate 121 is a substrate that covers both the side of the positive electrode 111 and the side of the negative electrode 112 of the cell member 110. In addition, the substrate 121 of the biplate 120 is a substrate (e.g., a main substrate) arranged between the cell members 110.

### Action and Effect

In the bipolar lead-acid storage battery 100 of the first embodiment, both the bottom surface of the recess 121b (surface of the substrate 121 close to the positive electrode 111) and the bottom surface of the recess 121c (surface of the substrate 121 close to the negative electrode 112), the substrate 121 being the main substrate, have a ten-point average roughness (RzJIS) of 30 μm or more and 104 μm or less (i.e., between 30 μm and 104 μm, inclusive) when measured in accordance with a stipulation of “Annex JA of JIS B 0601:2013”, and a maximum height roughness (Rz) of 123 μm or less when measured in accordance with the stipulation. Then, the positive electrode lead foil 111a is fixed to the surface of the substrate 121 close to the positive electrode 111 (i.e., the bottom surface of the recess 121b) with an adhesive, and the negative electrode lead foil 112a is fixed to the surface of the substrate 121 close to the negative electrode 112 (i.e., the bottom surface of the recess 121c) with an adhesive. Therefore, the bipolar lead-acid storage battery 100 can obtain the following action and effect.

In a case where the positive electrode lead foil 111a is corroded, the electrolytic solution present in the positive active material layer 111b tries to move to the substrate 121 through the corroded portion of the positive electrode lead foil 111a, but because the positive electrode lead foil 111a is fixed to the bottom surface of the recess 121b of the substrate 121 with an adhesive, the electrolytic solution is suppressed from reaching the bottom surface of the recess 121b of the substrate 121 due to the presence of the adhesive layer 150.

In addition, even in a case where the electrolytic solution reaches the bottom surface of the recess 121b of the substrate 121, a distance that the electrolytic solution reaching the bottom surface moves to the through-hole 121a of the substrate 121 becomes longer when a surface state of the bottom surface of recess 121b is rough (i.e., when the values of RzJIS and Rz are large) compared to when the surface state is smooth (i.e., when the values of RzJIS and Rz are small). Therefore, the electrolytic solution reaching the bottom surface hardly reaches the through-hole 121a, and occurrence of a liquid junction phenomenon is suppressed, such that a short circuit prevention effect of the bipolar lead-acid storage battery 100 can be expected.

On the other hand, when the surface states of the bottom surfaces of the first recess 121b and the second recess 121c are too rough, the amount of the adhesive required for fixing the positive electrode lead foil 111a and the negative electrode lead foil 111b having the same plane area increases, which causes an increase in cost. In addition, when bonding is performed with a predetermined amount of adhesive, the adhesive strength in the planes of the positive electrode lead foil 111a and the negative electrode lead foil 111b become uneven. In the bipolar lead-acid storage battery 100, the surface states of the bottom surfaces of the first recess 121b and the second recess 121c satisfy “RzJIS of 30 μm or more and 104 μm or less and Rz of 123 μm or less”, such that it can be expected to solve such a problem.

Note that, from the viewpoint of both the liquid junction suppression effect and the effect of capable of obtaining the required adhesive strength with a small amount of adhesive used, it is preferable that the surface states of the bottom surfaces of the first recess 121b and the second recess 121c (e.g., the surface of the main substrate close to the positive electrode and/or the surface of the main substrate close to the negative electrode) satisfy “RzJIS of 50 μm to 75 μm, and Rz of 20 μm to 90 μm”.

In addition, examples of the method for setting the surface states of the surface of the main substrate close to the positive electrode and/or the surface of the main substrate close to the negative electrode to have “RzJIS of 30 μm or more and 104 μm or less and Rz of 123 μm or less” include a method in which the surface of the main substrate after being molded with a synthetic resin is rubbed with sandpaper, a method in which the surface of the main substrate is subjected to emboss processing, and a method in which the surface of the main substrate is subjected to surface treatment such as sandblasting or shot blasting. Alternatively, when the main substrate is molded with a synthetic resin, a surface of a mold is roughly processed so that the surface state of the surface close to the positive electrode and/or the surface close to the negative electrode has “RzJIS of 30 μm or more and 104 μm or less and Rz of 123 μm or less”.

In addition, in the first embodiment, although the bipolar lead-acid storage battery in which the positive electrode current collector plate is formed of the positive electrode lead foil and the negative electrode current collector plate is formed of the negative electrode lead foil has been described, the first aspect of the present invention can also be applied to a bipolar storage battery in which a positive electrode current collector plate and a negative electrode current collector plate are formed of a metal other than lead (for example, aluminum, copper, or nickel), an alloy, or a conductive resin.

### Second Embodiment

### Overall Configuration

A bipolar lead-acid storage battery 100 of a second embodiment is the same as the bipolar lead-acid storage battery 100 of the first embodiment except for the following points.

In the first embodiment, each of the bottom surface of the first recess 121b (i.e., the surface of the substrate 121 close to the positive electrode 111) and the bottom surface of the second recess 121c (i.e., the surface of the substrate 121 close to the negative electrode 112) has a ten-point average roughness (RzJIS) of 30 μm or more and 104 μm or less (i.e., between 30 μm and 104 μm, inclusive) when measured in accordance with a stipulation of “Annex JA of JIS B 0601:2013”, and a maximum height roughness (Rz) of 123 μm or less when measured in accordance with the stipulation, but in the second embodiment, the current collector plate has the following configuration.

### Configuration of Current Collector Plate

The positive electrode lead foil 111a arranged in the recess 121b of the biplate 120 has a thickness of, for example, less than 0.5 mm (for example, 0.1 mm or more and 0.4 mm or less), and is formed of a heat treatment material for a rolled sheet formed of a lead alloy in which a content ratio of tin (Sn) is 1.0 mass % or more and 2.0 mass % or less (i.e., between 1.0 mass % and 2.0 mass %, inclusive), a content ratio of calcium (Ca) is 0.005 mass % or more and 0.030 mass % or less (i.e., between 0.005 mass % and 0.030 mass %, inclusive), and a balance is lead (Pb) and unavoidable impurities. A structure of the heat treatment material is a granular structure.

The positive electrode lead foil 111aa arranged in the recess 131b of the first end plate 130 has a thickness of, for example, 0.5 mm or more and 1.5 mm or less (i.e., between 0.5 mm and 1.5 mm, inclusive) and is formed of the same heat treatment material as the positive electrode lead foil 111a.

In addition, each of interfaces of the positive electrode lead foils 111a and 111aa with the positive active material layer 111b has a ten-point average roughness (RzJIS) of 50 μm or more when measured in accordance with a stipulation of “Annex JA of JIS B 0601:2013” and a maximum height roughness (Rz) smaller than ½ of a mean particle size of particles constituting a granular structure of each of the positive electrode lead foils 111a and 111aa when measured in accordance with the stipulation.

A thickness of the negative electrode lead foil 112a (the negative electrode current collector plate) arranged in the recess 121c of the biplate 120 is, for example, 0.05 mm or more and 0.3 mm or less (i.e., between 0.05 mm and 0.3 mm, inclusive). The alloy constituting the negative electrode lead foil 112a is, for example, a lead alloy in which a content ratio of tin (Sn) is 0.5 mass % or more and 2 mass % or less (i.e., between 0.5 mass % and 2 mass %, inclusive).

The negative electrode lead foil 112a (the negative electrode current collector plate) arranged in the recess 141b of the second end plate 140 has a thickness of, for example, 0.5 mm or more and 1.5 mm or less (i.e., between 0.5 mm and 1.5 mm, inclusive), and is formed of a lead alloy in which a content ratio of tin (Sn) is 0.5 mass % or more and 2 mass % or less (i.e., between 0.5 mass % and 2 mass %, inclusive).

### Action and Effect

In the bipolar lead-acid storage battery 100 of the second embodiment, because the positive electrode lead foils 111a and 111aa are formed of the heat treatment material for the rolled sheet formed of the lead alloy, the positive electrode lead foils 111a and 111aa have a granular structure. Therefore, the positive electrode lead foils 111a and 111aa are excellent in corrosion resistance. An interface with the positive active material layer 111b is a surface of a granular structure. In addition, each of the interfaces of the positive electrode lead foils 111a and 111aa with the positive active material layer 111b has a ten-point average roughness (RzJIS) of 50 μm or more when measured in accordance with the stipulation (configuration a) and a maximum height roughness (Rz) smaller than ½ of a mean particle size (A) of particles constituting a granular structure of each of the positive electrode lead foils 111a and 111aa when measured in accordance with the stipulation (configuration b).

As described above, the positive electrode lead foils 111a and 111aa are lead foils formed of a lead alloy having high corrosion resistance, but because the interface with the positive active material layer 111b satisfies both the above configuration a and configuration b, the adhesion to the positive active material layer 111b is high. Accordingly, because the positive active material is less likely to fall off from the positive electrode lead foils 111a and 111aa, high battery performance is maintained and a short circuit is prevented, such that a life improving effect of the bipolar lead-acid storage battery 100 can be expected.

On the other hand, when the ten-point average roughness (RzJIS) of each of the interfaces of the positive electrode lead foils 111a and 111aa with the positive active material layer 111b when measured in accordance with the stipulation is less than 50 μm, the adhesion to the positive active material layer 111b is significantly reduced. In addition, when the maximum height roughness (Rz) of each of the positive electrode lead foils 111a and 111aa when measured in accordance with the stipulation is A/2 or more, the positive electrode lead foils 111a and 111aa are easily corroded, such that penetration easily occurs.

Note that, in the bipolar lead-acid storage battery 100 of the second embodiment, the positive electrode lead foils 111a and 111aa are formed of a lead alloy having a granular structure and high corrosion resistance, and the interface with the positive active material layer 111b satisfies both the configuration a and configuration b. However, when the negative electrode lead foils 112a and 112aa are formed of a lead alloy having a granular structure and high corrosion resistance, and the interface with the negative active material layer 112b satisfies both the configuration a and configuration b, the same action and effect (because the active material is less likely to fall off, high battery performance is maintained, and a short circuit is prevented) can be obtained for the negative electrode.

In addition, even when the metallic structure of the lead foil is a granular structure, when the ten-point average roughness (RzJIS) of the interface with the active material layer is too large (the surface is too rough), a portion where the lead foil is partially thinned is generated, such that a risk of penetration of the lead foil during battery operation increases, and therefore RzJIS is preferably 50 μm or more and 70 μm or less (i.e., between 50 μm and 70 μm, inclusive). For the same reason, it is preferable that the maximum height roughness (Rz) is larger than the ten-point average roughness (RzJIS) and 1/7 or more and ½ or less (i.e., between 1/7 and ½, inclusive) of the mean particle size.

### EXAMPLES

### First Example

### Preparation of Biplate, Positive Electrode Current Collector Plate, and Negative Electrode Current Collector Plate

### Cutting Each Current Collector Plate

A rolled sheet formed of a lead alloy in which a content ratio of tin (Sn) was 1.0 mass % and a balance was lead (Pb) and unavoidable impurities and having a thickness of 0.30 mm was cut into square sheets having a side of 28 cm, thereby obtaining positive electrode current collector plates 111a for a biplate 120 of Sample Nos. 1-1 to 1-8. In addition, a rolled sheet containing the same lead alloy and having a thickness of 1.50 mm was cut into square sheets having a side of 28 cm, and the square sheets were used as positive electrode current collector plates 111aa for a first end plate 130 of Sample Nos. 1-1 to 1-8.

A rolled sheet formed of a lead alloy in which a content ratio of tin (Sn) was 1.0 mass % and a balance was lead (Pb) and unavoidable impurities and having a thickness of 0.1 mm was cut into square sheets having a side of 28 cm, thereby obtaining negative electrode current collector plates 112a for a biplate 120 of Sample Nos. 1-1 to 1-8. In addition, a rolled sheet formed of the same lead alloy and having a thickness of 1.50 mm was cut into square sheets having a side of 28 cm, and the square sheets were used as negative electrode current collector plates 112aa for a second end plate 140 of Sample Nos. 1-1 to 1-8.

### Preparation of Biplate

### Sample No. 1-1

A biplate 120 having the shape illustrated in FIG. 1 was prepared by injection molding of an acrylonitrile butadiene styrene (ABS) resin. A thickness of a substrate 121 of the biplate 120 was 2 mm. A bottom surface of a recess 121b was a square having a side of 28.5 cm, and a depth thereof was 0.32 mm. A bottom surface of a recess 121c was a square having a side of 28.5 cm, and a depth thereof was 0.12 mm.

When the surface state of the bottom surface of the recess 121b of the substrate 121 of the biplate 120 was measured based on the stipulation of “Annex JA of JIS B 0601:2013”, the ten-point average roughness (RzJIS) was 10 μm, and the maximum height roughness (Rz) was 17 μm.

### Sample No. 1-2

Bottom surfaces of a recess 121b and a recess 121c of a biplate 120 prepared in the same manner as that of Sample No. 1-1 were rubbed with No. 2000 sandpaper so that a ten-point average roughness (RzJIS) was 18 μm and a maximum height roughness (Rz) was 23 μm. This was used as a biplate of Sample No. 1-2.

### Sample No. 1-3

Bottom surfaces of a recess 121b and a recess 121c of a biplate 120 prepared in the same manner as that of Sample No. 1-1 were rubbed with No. 800 sandpaper so that a ten-point average roughness (RzJIS) was 30 μm and a maximum height roughness (Rz) was 39 μm. This was used as a biplate of Sample No. 1-3.

### Sample No. 1-4

Bottom surfaces of a recess 121b and a recess 121c of a biplate 120 prepared in the same manner as that of Sample No. 1-1 were rubbed with No. 800 sandpaper so that a ten-point average roughness (RzJIS) was 46 μm and a maximum height roughness (Rz) was 63 μm. This was used as a biplate of Sample No. 1-4.

### Sample No. 1-5

Bottom surfaces of a recess 121b and a recess 121c of a biplate 120 prepared in the same manner as that of Sample No. 1-1 were subjected to emboss processing so that a ten-point average roughness (RzJIS) was 69 μm and a maximum height roughness (Rz) was 155 μm. This was used as a biplate of Sample No. 1-5.

### Sample No. 1-6

Bottom surfaces of a recess 121b and a recess 121c of a biplate 120 prepared in the same manner as that of Sample No. 1-1 were rubbed with No. 150 sandpaper so that a ten-point average roughness (RzJIS) was 77 μm and a maximum height roughness (Rz) was 92 μm. This was used as a biplate of Sample No. 1-6.

### Sample No. 1-7

Bottom surfaces of a recess 121b and a recess 121c of a biplate 120 prepared in the same manner as that of Sample No. 1-1 were rubbed with No. 120 sandpaper so that a ten-point average roughness (RzJIS) was 104 μm and a maximum height roughness (Rz) was 123 μm. This was used as a biplate of Sample No. 1-7.

### Sample No. 1-8

Bottom surfaces of a recess 121b and a recess 121c of a biplate 120 prepared in the same manner as that of Sample No. 1-1 were rubbed with No. 80 sandpaper so that a ten-point average roughness (RzJIS) was 128 μm and a maximum height roughness (Rz) was 141 μm. This was used as a biplate of Sample No. 1-8.

### Preparation of End Plate

### Sample Nos. 1-1 to 1-8

A first end plate 130 and a second end plate 140 having the shapes illustrated in FIG. 1 were prepared by injection molding of an ABS resin. A thickness of each of a substrate 131 of the first end plate 130 and a substrate 141 of the second end plate 140 was 10 mm. A bottom surface of each of a recess 131b and a recess 141b was a square having a side of 28.5 cm, and a depth thereof was 1.52 mm.

### Assembly of Bipolar Lead-Acid Storage Batteries

Bipolar lead-acid storage batteries Nos. 1-1 to 1-8 were assembled to have the structure illustrated in FIG. 1 and a rated capacity of 45 Ah in the same method except that the biplates of Sample Nos. 1-1 to 1-8 were used. That is, all the samples had the same configuration except for the surface state of the bottom surface of the recess 121b of the substrate 121 of the biplate 120.

The bipolar lead-acid storage batteries each including the positive active material layer 111b and the negative active material layer 112b formed of a lead compound, and the separator 113 formed of a glass fiber, and each having a thickness corresponding to a rated capacity of 45 Ah were used.

### Life Test

First, each of the bipolar lead-acid storage batteries Nos. 1-1 to 1-8 was placed in a water tank in which a water temperature was controlled to 25° C.±2° C., the bipolar lead-acid storage battery was discharged at a 10-hour rate current (4.5 A) of a rated capacity (45 Ah) until a terminal voltage of the battery dropped to 1.8 V/cell, a discharge duration was recorded, and a 10-hour rate capacity was calculated from the discharge current and the discharge duration.

Next, after each bipolar lead-acid storage battery was fully charged, the following (1) was repeated 400 times while constantly measuring the terminal voltage.

(1) The battery is discharged at a 10-hour rate current (4.5 A) of a rated capacity (45 Ah) for 7 hours. That is, the battery is discharged at 70% Depth of Discharge (DOD) of the rated capacity.

When a liquid junction occurs, the terminal voltage rapidly drops. Whether or not a liquid junction occurred was determined by disassembling each battery after repeating the discharge 400 times and confirming whether or not the peripheral edge of the combined portion of the positive electrode lead foil 111a with the electrical conductor 160 was discolored by sulfuric acid. Then, the presence or absence of a liquid junction was determined from the degree of discoloration.

### Adhesive Application Test

First, as a test plate corresponding to each of the biplates 120 of Sample Nos. 1-1 to 1-8, a square plate formed of an ABS resin and having a thickness of 2 mm and a side of 30 cm was prepared so that the surface state of one surface of the square plate was the same as the surface state of each of the bottom surfaces of the recess 121b and the recess 121c of each of the biplates 120 of Sample Nos. 1-1 to 1-8.

Next, 25 ml of an adhesive was applied to one surface of the test plate for each sample. At that time, the substrate surface was held horizontally. Thereafter, a square sheet formed of a lead alloy and having a side of 28 cm was placed on the surface to which the adhesive was applied, a rubber roller was brought into contact with an upper surface of the sheet, and the sheet was moved from the end (e.g., the right end) toward the end (e.g., the left end), such that the sheet was attached while the adhesive was extended.

Next, it was examined whether the adhesive spread over the entire surface without any gap. As the adhesive, an epoxy-based adhesive “Epiform® K-9487” manufactured by SOMAR Corporation was used.

Note that, because the plate formed of an ABS resin and having a thickness of 2 mm has high transmittance, the state of the adhesive between the plate and the sheet can be examined by visually observing the other surface of the plate (i.e., the surface to which the lead alloy sheet is not attached).

The case where the adhesive spread over the entire surface without a gap was determined that the amount of the adhesive was sufficient (o), and the case where there was a gap was determined that the amount of the adhesive was insufficient (x).

These results are shown in Table 1 together with the surface state of the substrate (i.e., bottom surfaces of the recesses 121b and 121c and one surface of the test plate).

TABLE 1

| | Surface state of substrate | | | Evaluation | |
|---|---|---|---|---|---|
| | Surface | RzJIS | Rz | Amount of | Liquid |
| No. | treatment method | [μm] | [μm] | adhesive | junction |
| 1-1 | Non-treated | 10 | 17 | ○ | Presence |
| 1-2 | No. 2000 sandpaper | 18 | 23 | ○ | Presence |
| 1-3 | No. 800 sandpaper | 30 | 39 | ○ | Absence |
| 1-4 | No. 800 sandpaper | 46 | 63 | ○ | Absence |
| 1-5 | Emboss processing | 69 | 155 | x | Absence |
| 1-6 | No. 150 sandpaper | 77 | 92 | ○ | Absence |
| 1-7 | No. 120 sandpaper | 104 | 123 | ○ | Absence |
| 1-8 | No. 80 sandpaper | 128 | 141 | x | Absence |

The following was confirmed from the results of Table 1.

In the bipolar lead-acid storage batteries Nos. 1-3, 1-4, 1-6, and 1-7 in which the surface states of both surfaces (i.e., the surface close to the positive electrode and the surface close to the negative electrode) of the main substrate 121 satisfied “a ten-point average roughness (RzJIS) of 30 μm or more and 104 μm or less when measured in accordance with a stipulation of Annex JA of JIS B 0601:2013”, and a maximum height roughness (Rz) of 123 μm or less when measured in accordance with the stipulation, and the positive electrode current collector plate 111a and the negative electrode current collector plate 112a formed of a lead alloy were fixed to each surface with an adhesive, both the liquid junction suppression effect and the effect of obtaining the required adhesive strength with a small amount of adhesive used were achieved.

In the bipolar lead-acid storage batteries Nos. 1-2 and 1-3 in which RzJIS was less than 30 μm, the required adhesive strength was obtained with a small amount of adhesive used, but the liquid junction suppression effect was not obtained. In addition, in the bipolar lead-acid storage battery No. 1-5 in which RzJIS was 69 μm but Rz was more than 123 μm and the bipolar lead-acid storage battery No. 1-8 in which RzJIS was more than 104 μm and Rz was more than 123 μm, the liquid junction suppression effect was obtained, but the amount of adhesive for obtaining the required adhesive strength was increased.

### Second Example

### Preparation of Lead Foil

The lead foils Nos. 2-1 to 2-6 shown in Table 2 were prepared. The thickness of each lead foil was 0.35 mm.

### Sample No. 2-1

A lead foil of Sample No. 2-1 was obtained by subjecting a rolled sheet formed of a lead alloy in which a content ratio of calcium (Ca) was 0.030 mass %, a content ratio of tin (Sn) was 2.0 mass %, and a balance was lead (Pb) and unavoidable impurities to a heat treatment at 310° C. for 5 minutes in the air atmosphere.

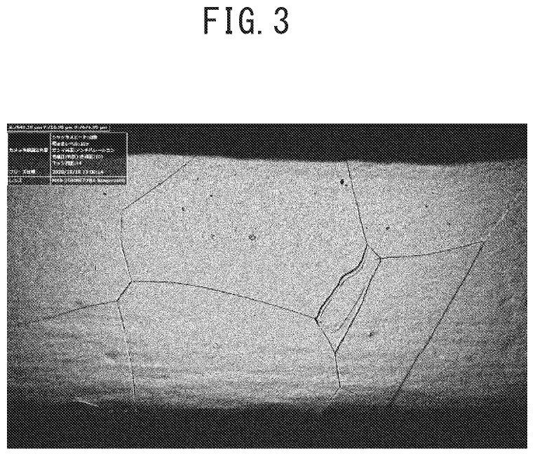

For the lead foil of Sample No. 2-1, a cross section perpendicular to a sheet surface and parallel to a rolling direction was imaged with an electron microscope. The micrograph is illustrated in FIG. 3. As can be seen from this image, the structure was a granular structure, and the mean particle size thereof was 160 μm.

When the surface state of the lead foil of Sample No. 2-1 was measured based on the stipulation of “Annex JA of JIS B 0601:2013”, the ten-point average roughness (RzJIS) was 20 μm, and the maximum height roughness (Rz) was 30 μm.

### Sample No. 2-2

One surface of the lead foil prepared in the same manner as that of Sample No. 2-1 was rubbed with No. 800 sandpaper so that a ten-point average roughness (RzJIS) was 30 μm and a maximum height roughness (Rz) was 45 μm. This was used as a lead foil of Sample No. 2-2. Note that the prepared lead foil had a similar granular structure to the lead foil No. 2-1, and the mean particle size thereof was 160 μm.

### Sample No. 2-3

One surface of the lead foil prepared in the same manner as that of Sample No. 2-1 was rubbed with No. 80 sandpaper so that a ten-point average roughness (RzJIS) was 50 μm and a maximum height roughness (Rz) was 60 μm. This was used as a lead foil of Sample No. 2-3. Note that the prepared lead foil had a similar granular structure to the lead foil No. 2-1, and the mean particle size thereof was 160 μm.

### Sample No. 2-4

One surface of the lead foil prepared in the same manner as that of Sample No. 2-1 was rubbed with No. 80 sandpaper so that a ten-point average roughness (RzJIS) was 50 μm and a maximum height roughness (Rz) was 70 μm. This was used as a lead foil of Sample No. 2-4. Note that the prepared lead foil had a similar granular structure to the lead foil No. 2-1, and the mean particle size thereof was 160 μm.

### Sample No. 2-5

One surface of the lead foil prepared in the same manner as that of Sample No. 2-1 was rubbed with No. 40 sandpaper so that a ten-point average roughness (RzJIS) was 70 μm and a maximum height roughness (Rz) was 110 μm. This was used as a lead foil of Sample No. 2-5. Note that the prepared lead foil had a similar granular structure to the lead foil No. 2-1, and the mean particle size thereof was 160 μm.

### Sample No. 2-6

A lead foil of Sample No. 2-6 was a rolled sheet formed of a lead alloy in which a content ratio of calcium (Ca) was 0.030 mass %, a content ratio of tin (Sn) was 2.0 mass %, and a balance was lead (Pb) and unavoidable impurities, and was not subjected to a heat treatment. One surface thereof was rubbed with No. 80 sandpaper so that a ten-point average roughness (RzJIS) was 50 μm and a maximum height roughness (Rz) was 70 μm.

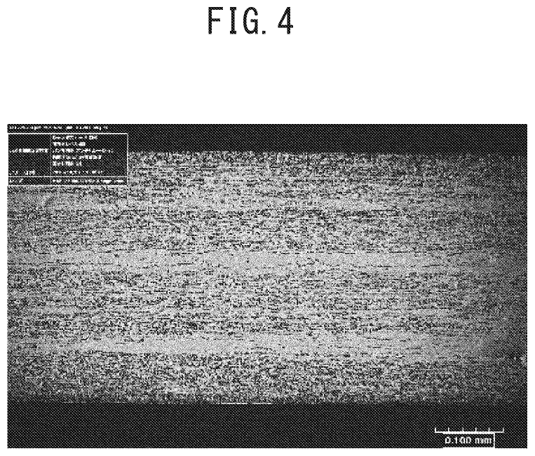

For the lead foil of Sample No. 2-6, a cross section perpendicular to a sheet surface and parallel to a rolling direction was imaged with an electron microscope, before rubbing with sandpaper. The micrograph is illustrated in FIG. 4. As can be seen from this image, a structure thereof was a striped structure.

### Corrosion Test

A corrosion test was performed on each of the lead foils Nos. 2-1 to 2-6 by the following method.

Each lead foil was cut into a test piece having a width of 15 mm and a length of 70 mm, the test piece was placed in sulfuric acid having a specific gravity of 1.28 at 60° C. and subjected to a continuous anodization at a constant potential of 1,350 mV (vs: Hg/Hg₂SO₄) for 28 days, and then a product oxide was removed. The mass was measured before and after the test, a mass loss by the test was calculated from the value, and a mass loss per total surface area of the test piece was taken as a corrosive amount. In addition, the cross section (i.e., cross section perpendicular to the sheet surface and parallel to the rolling direction) after the corrosion test was observed with an electron microscope (magnification: 400 times) to examine whether or not penetration occurred in the lead foil.

### Peeling Test of Active Material Layer

### Preparation of Biplate

A biplate 120 having the shape illustrated in FIG. 1 was prepared by injection molding of an ABS resin. A thickness of a substrate 121 of the biplate 120 was 2 mm. A bottom surface of each of a recess 121b and a recess 121c was a square having a side of 10.0 cm, and a depth of each of the recess 121b and the recess 121c was 0.37 mm.

### Preparation of End Plate

A first end plate 130 and a second end plate 140 having the shapes illustrated in FIG. 1 were prepared by injection molding of an ABS resin. A thickness of each of a substrate 131 of the first end plate 130 and a substrate 141 of the second end plate 140 was 10 mm. A bottom surface of each of a recess 131b and a recess 141b was a square having a side of 10.0 cm, and a depth thereof was 1.52 mm.

### Assembly of Bipolar Lead-Acid Storage Batteries

As the positive electrode lead foil 111a and the negative electrode lead foil 112a arranged in the recess 121b and the recess 121c, the lead foils of Sample Nos. 2-1 to 2-6 were cut into squares each having a side of 9.0 cm. The bipolar lead-acid storage batteries Nos. 2-1 to 2-6 having the structure illustrated in FIG. 1 and a nominal voltage of 6 V were assembled in the same manner except for this. That is, the respective bipolar lead-acid storage batteries had the same configuration except for the surface state of the surface of the active material layer of each of the positive electrode lead foil and the negative electrode lead foil.

The positive active material layer 111b had a thickness of 1.8 mm and was formed on the surfaces of the positive electrode lead foils 111a and 111aa. The negative active material layer 112b had a thickness of 1.6 mm and was formed on the surfaces of the negative electrode lead foils 112a and 112aa. The separator 113 was formed of a glass fiber. As the electrolytic solution, diluted sulfuric acid having a commonly used concentration was used.

### Observation of Peeling State of Active Material Layer

After chemically forming the assembled bipolar lead-acid storage batteries Nos. 2-1 to 2-6 under normal conditions, each bipolar lead-acid storage battery was disassembled, the positive electrode lead foil 111a was peeled off from the positive active material layer 111b, and the surface of the positive electrode lead foil 111a close to the positive active material layer 111b was observed with a microscope. By this observation, whether or not an active material remained in the positive electrode lead foil 111a was examined. When the active material remains, it can be determined that the adhesion of the positive active material layer 111b to the positive electrode lead foil 111a formed of a lead alloy having high corrosion resistance is excellent.

### Evaluation

The results of the corrosion test and the peeling test are shown in Table 2 together with the surface state of the lead foil.

TABLE 2

| | Surface state of lead foil | | | | | Evaluation | | |
|---|---|---|---|---|---|---|---|---|
| | Surface | | | | | Corrosive | | Residual active |
| | treatment | RzJIS | Rz | Metallic | | amount | Penetration | material after |
| No. | method | [μm] | [μm] | structure | Rz < A/2 | [mg/cm2] | of lead foil | peeling test |
| 2-1 | Non-treated | 20 | 30 | Granular | Satisfied | Less than 20 | Absence | Absence |
| | | | | structure | | | | |
| 2-2 | No. 800 | 30 | 45 | Granular | Satisfied | Less than 20 | Absence | Absence |
| | sandpaper | | | structure | | | | |
| 2-3 | No. 80 | 50 | 60 | Granular | Satisfied | Less than 20 | Absence | Presence |
| | sandpaper | | | structure | | | | |
| 2-4 | No. 80 | 50 | 70 | Granular | Satisfied | Less than 20 | Absence | Presence |
| | sandpaper | | | structure | | | | |
| 2-5 | No. 40 | 70 | 110 | Granular | Not | Less than 20 | Presence | Presence |
| | sandpaper | | | structure | satisfied | | | |
| 2-6 | No. 80 | 50 | 70 | Striped | — | 20 or more | Absence | Presence |
| | sandpaper | | | structure | | | | |

The following was confirmed from the results of Table 2.

The lead foils Nos. 2-1 to 2-5 had high corrosion resistance because they were formed of a lead alloy having a granular structure. However, the lead foils Nos. 2-1 and 2-2 satisfied “Rz<A/2” but did not satisfy “RzJIS≥50 μm”, and therefore the adhesion of the active material layer was low. In addition, the lead foil No. 2-5 satisfied “RzJIS≥50 μm” but did not satisfy “Rz<A/2”, such that penetration occurred in the lead foil. On the other hand, the lead foils Nos. 2-3 and 2-4 satisfied both “Rz<A/2” and “RzJIS≥50 μm”, such that the adhesion of the active material layer was high, and no penetration occurred in the lead foil.

Furthermore, the lead foil No. 2-6 was low in corrosion resistance because it was formed of a lead alloy having a striped structure.

Therefore, according to the bipolar lead-acid storage batteries using the lead foils Nos. 2-3 and 2-4 as the positive electrode lead foils, it is presumed that because the positive active material is less likely to fall off from the positive electrode lead foil, high battery performance is maintained and a short circuit is prevented, such that the life is improved as compared with the bipolar lead-acid storage batteries using the lead foils Nos. 2-1, 2-2, and 2-6 as the positive electrode lead foils.

The following is a list of reference signs used in this specification and in the drawings.
100 Bipolar lead-acid storage battery
110 Cell member
111 Positive electrode
112 Negative electrode
111a Positive electrode lead foil (positive electrode current collector plate arranged on surface of main substrate close to positive electrode)
111aa Positive electrode lead foil (positive electrode current collector plate)
111b Positive active material layer
112a Negative electrode lead foil (negative electrode current collector plate arranged on surface of main substrate close to negative electrode)
112aa Negative electrode lead foil (negative electrode current collector plate)
112b Negative active material layer
111c Through-hole
112c Through-hole
111d Through-hole
112d Through-hole
113 Separator
113a Through-hole
120 Biplate
121 Substrate of biplate (substrate arranged between cell members adjacent to each other, main substrate)
121a Through-hole of substrate
121b First recess of substrate
121c Second recess of substrate
122 Frame body of biplate
123 Column portion
130 First end plate
131 Substrate of first end plate
131b Recess
132 Frame body of first end plate
133 Column portion
140 Second end plate
141 Substrate of second end plate
141b Recess
142 Frame body of second end plate
143 Column portion
150 Adhesive layer
160 Electrical conductor
C Cell (space housing cell member)

What is claimed is:

1. A bipolar storage battery, comprising:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members, each space forming member forming a plurality of spaces for individually housing the plurality of cell members,
wherein each space forming member includes a substrate formed of a synthetic resin that covers at least one of a side of the positive electrode or a side of the negative electrode of a cell member and a frame body that surrounds a side surface of the cell member,
the plurality of cell members and the substrate of each space forming member are arranged to be alternately stacked, and frame bodies adjacent to each other are joined to each other,
at least one of a surface of a main substrate close to the positive electrode and a surface of the main substrate close to the negative electrode, the main substrate being the substrate arranged between the cell members adjacent to each other, has a ten-point average roughness (RzJIS) of 30 μm or more and 104 μm or less when measured in accordance with a stipulation of “Annex JA of JIS B 0601:2013”, and a maximum height roughness (Rz) of 123 μm or less when measured in accordance with the stipulation,
the positive electrode current collector plate formed of a metal is fixed to the surface of the main substrate close to the positive electrode with an adhesive,
the negative electrode current collector plate formed of a metal is fixed to the surface of the main substrate close to the negative electrode with an adhesive, and
the main substrate has a through-hole extending in a direction intersecting with a plate surface, the positive electrode current collector plate and the negative electrode current collector plate of adjacent cell members are electrically connected to each other in the through-hole, and the plurality of cell members are electrically connected in series.

2. The bipolar storage battery according to claim 1, wherein the positive electrode current collector plate and the negative electrode current collector plate are formed of lead or a lead alloy.

3. A method for manufacturing a bipolar storage battery, wherein the bipolar storage battery includes:
a plurality of cell members each including a positive electrode including a positive electrode current collector plate and a positive active material layer, a negative electrode including a negative electrode current collector plate and a negative active material layer, and a separator interposed between the positive electrode and the negative electrode, the plurality of cell members being arranged in a stack manner with intervals; and
a plurality of space forming members, each space forming member forming a plurality of spaces for individually housing the plurality of cell members,
each space forming member includes a substrate formed of a synthetic resin that covers at least one of a side of the positive electrode or a side of the negative electrode of a cell member, and a frame body that surrounds a side surface of the cell member,
the plurality of cell members and the substrate of each space forming member are arranged to be alternately stacked,
frame bodies adjacent to each other are joined to each other,
the positive electrode current collector plate formed of a metal is fixed to a surface of a main substrate close to the positive electrode with an adhesive, the main substrate being a substrate arranged between the cell members adjacent to each other,
the negative electrode current collector plate formed of a metal is fixed to a surface of the main substrate close to the negative electrode with an adhesive,
the main substrate has a through-hole extending in a direction intersecting with a plate surface, the positive electrode current collector plate and the negative electrode current collector plate of the cell members adjacent to each other are electrically connected to each other in the through-hole, and the plurality of cell members are electrically connected in series, and
as the main substrate, a main substrate, in which at least one of the surface of the main substrate close to the positive electrode or the surface of the main substrate close to the negative electrode has a ten-point average roughness (RzJIS) of 30 μm or more and 104 μm or less when measured in accordance with a stipulation of “Annex JA of JIS B 0601:2013”, and a maximum height roughness (Rz) of 123 μm or less when measured in accordance with the stipulation, is used.

4. A bipolar lead-acid storage battery, comprising:
a plurality of cell members each including a positive electrode in which a positive active material layer is arranged on one surface of a positive electrode lead foil formed of lead or a lead alloy, a negative electrode in which a negative active material layer is arranged on one surface of a negative electrode lead foil formed of lead or a lead alloy, and a separator interposed between the positive electrode and the negative electrode, the plurality of cell members being arranged in a stack manner with intervals; and
a plurality of space forming members, each space forming member forming a plurality of spaces for individually housing the plurality of cell members,
wherein each space forming member includes a substrate that covers at least one of a side of the positive electrode or a side of the negative electrode of a cell member and a frame body that surrounds a side surface of the cell member,
the plurality of cell members and the substrate of each space forming member are arranged to be alternately stacked, and frame bodies adjacent to each other are joined to each other,
the positive electrode lead foil and the negative electrode lead foil each have a portion having a granular structure,
at least one of an interface of the positive electrode lead foil with the positive active material layer or an interface of the negative electrode lead foil with the negative active material layer has a portion formed in the granular structure, and has a ten-point average roughness (RzJIS) of 50 μm or more when measured in accordance with a stipulation of “Annex JA of JIS B 0601:2013”, and a maximum height roughness (Rz) smaller than ½ of a mean particle size of particles constituting the granular structure when measured in accordance with the stipulation, and
the substrate arranged between the cell members adjacent to each other adjacent cell members has a through-hole extending in a direction intersecting with a plate surface, the positive electrode lead foil and the negative electrode lead foil of the adjacent cell members are electrically connected to each other in the through-hole, and the plurality of cell members are electrically connected in series.
